(19) United States
(12) Patent Application Publication
(10) Pub. No.: US 2025/0267008 A1
(43) Pub. Date: Aug. 21, 2025

(54) SECURED EFFICIENT LIGHTWEIGHT RICH UI IDENTIFICATION OF A BSS OR ESS

(71) Applicant: SAMSUNG ELECTRONICS CO., LTD., Suwon-si (KR)

(72) Inventors: Daniel Alexandru LUNGU, Cambridge (GB); Mark Gorthorn RISON, Cambridge (GB)

(73) Assignee: SAMSUNG ELECTRONICS CO., LTD., Suwon-si (KR)

(21) Appl. No.: 18/812,661

(22) Filed: Aug. 22, 2024

(30) Foreign Application Priority Data
Feb. 19, 2024 (KR) 10-2024-0023665
Mar. 6, 2024 (KR) 10-2024-0032253

(51) Int. Cl. H04L 9/32; H04L 9/08; H04W 84/12

(52) U.S. Cl. CPC H04L 9/3247; H04L 9/0825; H04W 84/12

(57) ABSTRACT

A client device, including: a transceiver; at least one processor; and a memory configured to store instructions which, when executed by the at least one processor, cause the client device to: receive an initial message from an access point (AP) associated with a wireless network, transmit, to the AP, a validation request message for validating the wireless network using a public key infrastructure (PKI), receive, from the AP, a response message including an AP public key, a first digital signature that is generated based on the AP public key using a PKI private key, AP information regarding the AP, and a second digital signature that is generated based on the AP information using an AP private key, and validate the wireless network using the AP public key, the first digital signature, the AP information, and the second digital signature.

### CROSS-REFERENCE TO RELATED APPLICATION

This application is based on and claims priority under 35 U.S.C. § 119 to Korean Patent Application No. 10-2024-0023665, filed on Feb. 19, 2024, and Korean Patent Application No. 10-2024-0032253, filed on Mar. 6, 2024, in the Korean Intellectual Property Office, the disclosures of which are incorporated by reference herein in their entireties.

### BACKGROUND

### 1. Field

The disclosure relates to identifying and validating a wireless network, for example an Institute of Electrical and Electronics Engineers (IEEE) 802.11 wireless local area network (WLAN) system.

### 2. Description of Related Art

A Wi-Fi network (e.g., a basic service (BSS) and/or an extended service set (ESS)) may be identified by an identifier such as a service set identifier (SSID) and/or a basic service set identifier (BSSID). An identifier such as an SSID and/or a BSSID may be an octet string, and may often be a text string such as an American Standard Code for Information Interchange ASCII) string or a Unicode string. For example, an SSID may be up to thirty-two octets long, which may limit the richness of the user interface that may be presented to a user for network selection, and may also make it difficult for the user to find a desired network, or to be sure that the correct network is selected. In addition, because these identifiers represent a flat hierarchy, this limits the granularity by which networks may be identified.

### SUMMARY

Provided are methods, devices, and systems for verifying an authenticity of a network using a digital signature, and for indicating that the network has been verified, for example using an icon or other media that may be richer than text. The public key for the digital signature may be provided by a vendor such as a device vendor or operating system vendor, based on a prior agreement with the operator of the network, and may allow verification that association is being made to the network and not an impostor network.

In accordance with an aspect of the disclosure, a client device includes: a transceiver; at least one processor; and a memory configured to store instructions which, when executed by the at least one processor, cause the client device to: receive an initial message from an access point (AP) associated with a wireless network, transmit, to the AP, a validation request message for validating the wireless network using a public key infrastructure (PKI), wherein the PKI is associated with a PKI public key and a PKI private key, receive, from the AP, a response message including an AP public key associated with the AP, a first digital signature that is generated based on the AP public key using the PKI private key, AP information regarding the AP, and a second digital signature that is generated based on the AP information using an AP private key associated with the AP, and validate the wireless network using the AP public key, the first digital signature, the AP information, and the second digital signature.

In accordance with an aspect of the disclosure, a client device includes: a transceiver; a display; at least one processor; and a memory configured to store instructions which, when executed by the at least one processor, cause the client device to: receive an initial message from an access point (AP) associated with a wireless network, wherein the initial message includes a first icon corresponding to the wireless network and an AP identifier corresponding to the AP, display the first icon on the display, based on the AP identifier, obtain an AP public key associated with the AP, transmit, to the AP, a validation request message for validating the wireless network, receive, from the AP, a response message including a second icon associated with the wireless network and a digital signature that is generated based on the second icon using an AP private key associated with the AP, validate the wireless network using the second icon, the digital signature, and the AP public key, and based on the wireless network being validated, display the second icon on the display.

In accordance with an aspect of the disclosure, a method of validating a wireless network is performed by at least one processor included in a client device, and includes: receiving an initial message from an access point (AP) associated with the wireless network; transmitting, to the AP, a validation request message for validating the wireless network using a public key infrastructure (PKI), wherein the PKI is associated with a PKI public key and a PKI private key; receiving, from the AP, a response message including an AP public key associated with the AP, a first digital signature that is generated based on the AP public key using the PKI private key, AP information regarding the AP, and a second digital signature that is generated based on the AP information using an AP private key associated with the AP; and validating the wireless network using the AP public key, the first digital signature, the AP information, and the second digital signature.

In accordance with an aspect of the disclosure, a method of validating a wireless network is performed by at least one processor included in a client device, and includes: receiving an initial message from an access point (AP) associated with the wireless network, wherein the initial message includes a first icon corresponding to the wireless network and an AP identifier corresponding to the AP, displaying the first icon on a display included in the client device, based on the AP identifier, obtaining an AP public key associated with the AP, transmitting, to the AP, a validation request message for validating the wireless network, receiving, from the AP, a response message including a second icon associated with the wireless network and a digital signature that is generated based on the second icon using an AP private key associated with the AP, validating the wireless network using the second icon, the digital signature, and the AP public key, and displaying the second icon on the display.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates an overall structure of an example of a wireless communication system, according to embodiments;

FIG. 2 illustrates a wireless communication system, according to embodiments;

FIGS. 3 and 4 are flowcharts showing examples of processes for validating at least one of an access point and an icon corresponding to the access point, according to embodiments.

FIGS. 5A-5D show examples of a network picker user interfaces (UI) which may be displayed by a client device.

FIGS. 6 and 7 are flowcharts showing examples of processes for validating a network, according to embodiments.

### DETAILED DESCRIPTION

The terms as used in the disclosure are provided to merely describe specific embodiments, not intended to limit the scope of other embodiments. Singular forms include plural referents unless the context clearly dictates otherwise. The terms and words as used herein, including technical or scientific terms, may have the same meanings as generally understood by those skilled in the art. The terms as generally defined in dictionaries may be interpreted as having the same or similar meanings as or to contextual meanings of the relevant art. Unless otherwise defined, the terms should not be interpreted as ideally or excessively formal meanings. Even though a term is defined in the disclosure, the term should not be interpreted as excluding embodiments of the disclosure under other circumstances.

According to one or more embodiments, the electronic device may be one of various types of electronic devices. The electronic devices may include, for example, a network device, a router, an access point device, a terminal station in a wireless system, a portable communication device (e.g., a smartphone), a computer device, a portable multimedia device, a portable medical device, a camera, a wearable device, or a home appliance. According to an embodiment of the disclosure, the electronic devices are not limited to those described above.

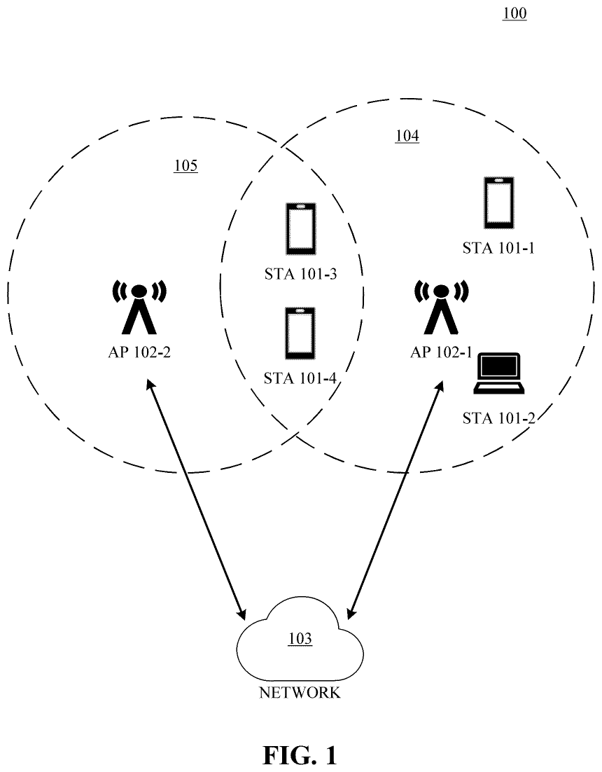

FIG. 1 illustrates an example structure of a wireless communication system, according to embodiments.

Throughout the disclosure, examples are described which relate to the Institute of Electrical and Electronics Engineers (IEEE) 802.11 wireless LAN (WLAN) standards, the contents of which are incorporated by reference herein in their entirety. However, embodiments are not limited thereto. For example, some embodiments may be applied to other communication systems (e.g., a cellular communication system such as long term evolution (LTE), LTE-advanced (LTE-A), new radio (NR), wireless broadband (WiBro), a global system for mobile communication (GSM), or a short-range communication system such as Bluetooth and near field communication (NFC)) with a similar technical background and channel form with slight modifications without departing from the scope of the disclosure, as may be determined by one of ordinary skill in the art.

As shown in FIG. 1, the wireless communication system 100 may include a first station (STA) 101-1, a second STA 101-2, a third STA 101-3, a fourth STA 101-4, a first access point (AP) 102-1, and a second AP 102-2. The first AP 102-1 and the second AP 102-2 may access a network 103 that may include the Internet, an Internet protocol (IP) network, a distribution network (DN), or any other network.

The first AP 102-1 may provide the first STA 101-1, the second STA 101-2, the third STA 101-3, and the fourth STA 101-4 with access to the network 103 within a first basic service set (BSS) 104. The second AP 102-2 may provide the third STA 101-3 and the fourth STA 101-4 with access to the network 103 within a second BSS 105. In embodiments, a BSS may be a basic building block of the IEEE 802.11 WLAN system.

In embodiments, the first AP 102-1 may communicate with at least one of the first STA 101-1, the second STA 101-2, the third STA 101-3, and the fourth STA 101-4 based on IEEE 802.11 Wi-Fi, or any other WLAN access technology.

In some embodiments, an AP (e.g., the first AP 102-2 and/or the second AP 102-2) may be referred to as a router, a gateway, and the like. In some embodiments, an STA (e.g., the first STA 101-1, the second STA 101-2, the third STA 101-3, and/or the fourth STA 101-4) may be referred to as a mobile station, a subscriber station, a terminal, a mobile terminal, a wireless terminal, user equipment, a user, and the like. The STA may be a mobile device, such as a mobile phone, a laptop computer, a wearable device, or the like, or a stationary device, such as a desktop computer, a smart TV, or the like.

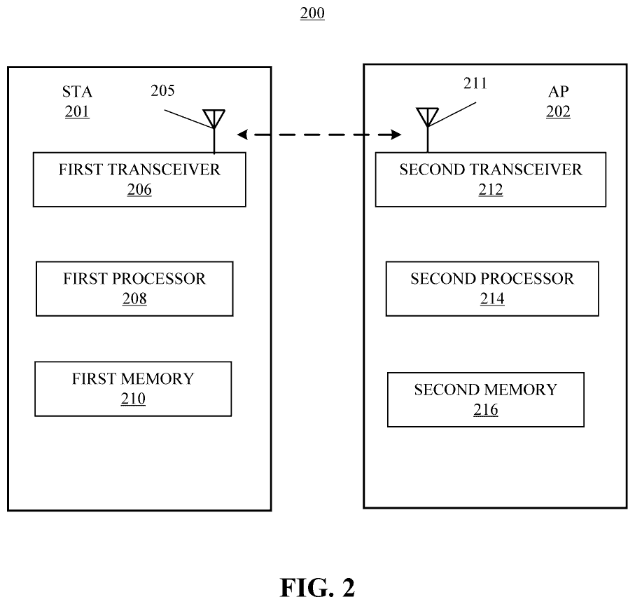

FIG. 2 illustrates a wireless communication system 200 in accordance with embodiments of the disclosure. FIG. 2 illustrates an STA 201 and an AP 202 that communicate with each other in the wireless communication system 200. In embodiments, the STA 201 may be referred to as a first electronic device and the AP 202 may be referred to as a second electronic device, but embodiments are not limited thereto. Each of the AP 202 and the STA 201 of FIG. 2 may be any apparatus communicating or configured to communicate in the wireless communication system 200 and may be referred to as an apparatus for wireless communication. In some embodiments, the STA 201 may correspond at least one of the at least one of the first STA 101-1, the second STA 101-2, the third STA 101-3, and the fourth STA 101-4.

In FIG. 2, the STA 201 may include a first antenna 205, a first transceiver 206, a first processor 208, and a first memory 210. Similarly, the AP 202 may include a second antenna 211, a second transceiver 212, a second processor 214, and a second memory 216.

In embodiments, the first antenna 205, the first transceiver 206, the first processor 208, and the first memory 210 may be included in one package or may be included in different packages, respectively. In embodiments, the second antenna 211, the second transceiver 212, the second processor 214, and the second memory 216 may be included in one package or may be included in different packages, respectively.

In embodiments, the first antenna 205 may receive a signal from the second antenna 211 and provide the received signal to the first transceiver 206, and may transmit the signal provided from the first transceiver 206 to the second antenna 211. Similarly, the second antenna 211 may receive a signal from the first antenna 205 and provide the received signal to the second transceiver 212, and may transmit the signal provided from the second transceiver 212 to the first antenna 205.

In embodiments, the first transceiver 206 may process a signal received from the STA 201 through the first antenna 205, and may provide the processed signal to the first processor 208. In embodiments, the first transceiver 206 may process the signal provided from the first processor 208 and output the processed signal through the first antenna 205. The second transceiver 212 may similarly perform the above functions performed by the first transceiver 206.

In embodiments, the first transceiver 206 and the second transceiver 212 may include one or more circuits such as a low noise amplifier, a mixer, a filter, a power amplifier, an oscillator, and the like.

In embodiments, the first processor 208 may extract information transmitted by the AP 202 by processing the signal received from the first transceiver 206. For example, the first processor 208 may extract information by demodulating and/or decoding a signal received from the first transceiver 206.

In embodiments, the first processor 208 may generate a signal including information to be transmitted to the AP 202 and provide the signal to the first transceiver 206. In embodiments, the first processor 208 may provide a signal generated by encoding and/or modulating data to be transmitted to the STA 201 to the first transceiver 206. The second processor 214 may similarly perform the above functions performed by the first processor 208 with respect to information transmitted by the STA 201 and information to be transmitted to the STA 201.

In embodiments, the first processor 208 and the second processor 214 may include a programmable component such as a central processing unit (CPU), a digital signal processor (DSP), and the like, may include reconfigurable components, such as field programmable gate arrays (FPGAs), and may include a component that provides a fixed function, such as an intellectual property (IP) core.

In embodiments, the first processor 208 may include or access the first memory 210 that stores data and/or a series of instructions. In embodiments, the second processor 214 may include or access the second memory 216 that stores data and/or a series of instructions.

As discussed above, a network (e.g., a WLAN such as the BSS discussed above, or an extended service set (ESS)), may be identified by an identifier such as a service set identifier (SSID) and/or a basic service set identifier (BSSID). For example, an SSID may be an octet string up to thirty-two octets long, which may limit the richness of the user interface that may be presented to a user for network selection, and may also make it difficult for the user to find a desired network, or to be sure that the correct network is selected.

In some embodiments, the AP may send an icon in an initial message to the client device. For example, the initial message may be at least one of a beacon frame and a probe response frame, or in one or more frames such as broadcast frames which may be, for example, transmitted after the beacon frame or probe response frame. In some embodiments, the icon may be in a portable network graphics (PNG) format or a scalable vector graphics (SVG) format. For example, the icon may be a favicon, which may have a size of 32×32 pixels at eight bits per pixel (bpp), which may be approximately one kilobyte (kB) uncompressed, or a size of 32×32 pixels with a sixteen-colour palette or a size of 16×16 pixels at eight bpp, which may be approximately 256 bytes (B) uncompressed, which may be suitable for inclusion in a beacon frame. However, embodiments are not limited thereto, and for example in some embodiments the AP may provide information about the initial icon, for example a uniform resource locator (URL) at which the initial icon may be found. In some embodiments, the AP may not send the initial icon in every beacon period, and instead the beacon frame may indicate when the next transmission of the icon will occur.

However, this approach may provide little or no security, because an attacker may supply a malicious icon, or infringe on a trademark. In some embodiments, display of the icons on devices used by children and sensitive adults, or in sensitive markets, may be limited, or objectionable content may be filtered out, for example using artificial intelligence (AI). In addition, according to embodiments, it may be possible to add security to the network association process, examples of which are discussed below.

According to embodiments, network operator may establish a relationship with a public key infrastructure (PKI) to assist in validating the network, which may refer to verifying the authenticity of the network. In some embodiments, the PKI may be a vendor such as a device vendor or operating system vendor. For example, the PKI may provide a user, or a client device of the user, with access to a database of public keys. In some embodiments, the database of public keys may be indexed by information indicating an AP associated with the network, which may be referred to for example as an AP identifier. For example, the AP identifier may include one or more of an SSID, a basic service set identifier (BSSID), a string which may be tagged to the network or the AP, and a location of the AP. Maintaining this database may have operational and administrative costs, but these costs may be recouped by requiring network operators to pay for the enhanced security as well as the enhanced visibility which may be provided by the icons. In some embodiments, the PKI database may be federated in some way, but this may be transparent to the client device, which may have one point of contact with the PKI.

According to embodiments, the network provider and the PKI may establish a relationship in which the PKI may provide the public key to any device that asks for it, based on this AP indexing. The PKI may not have access to the private key corresponding to the AP, and may not have any control over how the keys are used. Therefore, the network provider may have a responsibility to ensure that the private key is kept private, and that any content protected using the private key (e.g. graphics) obeys applicable trademark, copyright, etc. laws, as well as laws on objectionable content. The network operator may certify that any AP identifier provided by the network operator to the PKI is associated with an AP that is owned and/or operated by the network operator. The PKI may validate to the network operator that any AP identifier provided by the network operator is not already in the database. In some embodiments, because there may be no guarantees about SSID uniqueness, the PKI may operate on a first-come/first-served basis. In some embodiments, the PKI may use a globally unique string, or for example another identifier which is selected by agreement with the network operator. In some embodiments, the PKI may request the network operator to certify that any terms used in the AP identifier are either generic or trademarks owned by the network operator so that a trademark owner will not find their AP identifier is already taken.

In some embodiments, the PKI may allow the network operator to securely update its AP public key in the PKI database, for example at a specific time, to ensure synchronisation, and may also allow the network operator to notify the PKI that the AP public key has been compromised and should no longer be signed by PKI.

Accordingly, embodiments may allow the network to be validated, which may refer to verifying the authenticity of the network, using a digital signature, and may allow the validation to be indicated using the icon. For example, the user may have a pre-existing relationship with the PKI, which may allow the operator of the network to leverage the established trust between the user and the PKI to establish its own authenticity. In some embodiments, a public key corresponding to an AP associated with the network may be provided to a client device of the user using the PKI based on a prior agreement between the PKI and the operator of the network, which may allow the client device to verify that association is being made to the network and not an impostor network.

For example, an AP associated with the network may obtain a digital signature generated by the PKI based on the AP public key (or for example a concatenation of the AP public key and a salt value chosen by the client device) using a private key corresponding to the PKI, and may provide the digital signature to the client device. The AP may provide the AP public key and the corresponding digital signature to the client device, and the client device may then validate the AP public key based on the digital signature and a public key corresponding to the PKI. In some embodiments, after the AP and the network are validated, the client device may validate the icon using the validated AP public key, and may display the validated icon to the user to assist in network selection.

As another example, when a client wishes to validate a network associated with an AP, and/or an icon received from an AP, the client device may request the AP public key from the PKI based on the AP identifier, for example over a secured channel established between the client device and the PKI. If the AP public key is located in the PKI database, the client device may then request the icon from the AP, along with the digital signature of the icon data (or for example the concatenation of the icon data and a salt value chosen by the client device), examples of which are discussed in greater detail below. The digital signature may be generated based on the AP public key, or a shared secret such as a Diffie-Hellman (DH) shared secret created based on the AP public key and a DH public key sent by the client. If the digital signature checks out properly, the icon may be displayed by the client device to the user. In some embodiments, an initial icon (e.g., a favicon received in a beacon frame) may be displayed before the signature is received, and then may be replaced with a full icon or validated icon after the network is validated by the client device. According to embodiments, if the digital signature does not check out properly, a warning may be displayed by the client device. In some embodiments, this warning may be only displayed if an invalid response was received and no valid response was received, and only be a “soft” warning, to avoid dissuasion of service attacks.

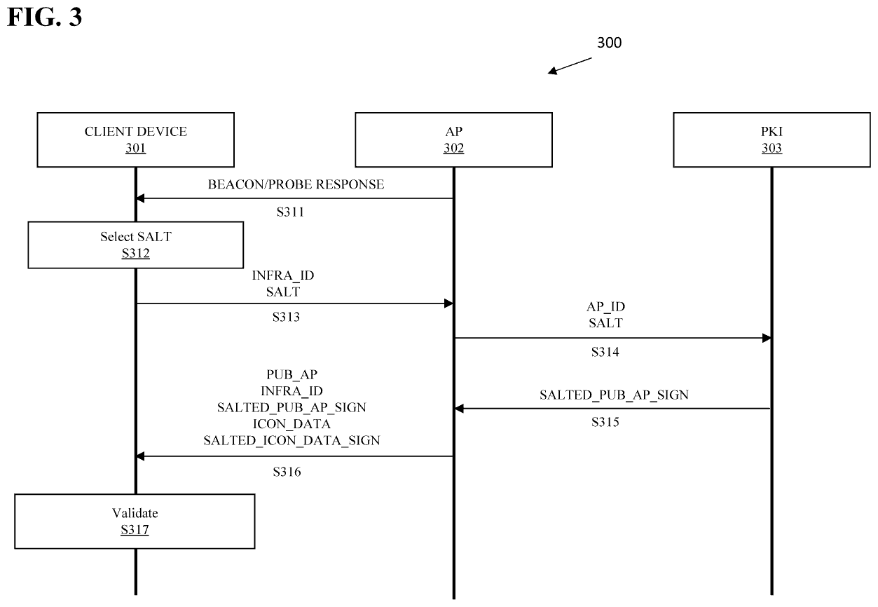

FIG. 3 is a diagram showing an example of a process for validating at least one of an AP and an icon corresponding to the AP, according to embodiments.

As shown in FIG. 3, at operation S311, an AP 302 may transmit an initial message to a client device 301. In some embodiments, the AP 302 may correspond to the APs 102 and the AP 202 discussed above, and the client device 301 may correspond to the STAs 101 and the STA 201 discussed above, but embodiments are not limited thereto. The initial message may be a beacon frame or a probe response frame, but embodiments are not limited thereto. The initial message may indicate to the client device that the AP 302 is able to prove that it is trustworthy (e.g., may indicate that the AP 302 can be validated), and/or that the AP 302 is able to provide an icon to the client device 301.

As further shown in FIG. 3, at operation S312, the client device 301 may select a salt value SALT. In some embodiments, the salt value SALT may be a value that is sufficiently large and random that it is implausible the same value would be chosen again by the client device 301. The salt value SALT may prevent an attacker from replaying an old icon, and may also allow the client device to determine whether an attacker is operating an impostor network (e.g., an “evil twin” or “honeypot”).

As further shown in FIG. 3, at operation S313, the client device 301 may transmit a validation request message to the AP 302. In some embodiments, the validation request message may be, or may be included in, an unprotected Public Action frame, for example a generic advertisement service (GAS) or access network query protocol (ANQP) Initial Request frame, but embodiments are not limited thereto. The validation request message may include an infrastructure identifier INFRA_ID of a PKI 303 for which the client device has a PKI public key PUB_INFRA[INFRA_ID], as well as the salt value SALT. The validation request message may request that the AP 302 provide the AP public key PUB_AP, the infrastructure identifier INFRA_ID of the PKI 303 used by the AP 302, and a first digital signature SALTED_PUB_AP_SIGN corresponding to the AP public key PUB_AP. For example, the first digital signature SALTED_PUB_AP_SIGN may be generated by the PKI 303 based on a concatenation PUB_AP∥SALT of the AP public key PUB_AP and the salt value SALT, using the PKI private key PRIV_INFRA[INFRA_ID]. In embodiments, the first digital signature SALTED_PUB_AP_SIGN may be expressed as SIGN(PRIV_INFRA[INFRA_ID], PUB_AP∥SALT). In some embodiments, the client device 301 may provide a list of infrastructure identifiers INFRA_ID, and the AP 302 may select the PKI 303 based on the list.

In some embodiments, the validation request message may also request that the AP 302 provide icon data ICON_DATA which represents the icon (in whatever format), as well as a second digital signature SALTED_ICON_DATA_SIGN corresponding to the icon data ICON_DATA. For example, the second digital signature SALTED_ICON_DATA_SIGN may be generated by the AP 302 based on a concatenation ICON_DATA∥SALT of the icon data ICON_DATA and the salt value SALT, using the AP private key PRIV_AP. In embodiments, the second digital signature SALTED_ICON_DATA_SIGN may be expressed as SIGN(PRIV_AP, ICON_DATA∥SALT). In some embodiments, the validation request message may request that the AP 302 sign multiple pieces of media, (e.g. multiple icons in different sizes, or an icon and an audio sample).

As further shown in FIG. 3, at operation S314, the AP 302 may transmit a message to the PKI 303 corresponding to the infrastructure identifier INFRA_ID. The request may include an AP identifier AP_ID of the AP 302 as well as the salt value SALT, and may request the PKI 303 to return the AP public key PUB_AP corresponding to the AP 302 as we as the first digital signature SALTED_PUB_AP_SIGN. In some embodiments, this request may be not protected. The AP 302 may send multiple requests to multiple PKIs in parallel, and may continue sending requests until a PKI that is able to assist in validating the AP 302 to the client device 301 is found.

As further shown in FIG. 3, at operation S315, if the PKI 303 is able to find the AP public key PUB_AP, the PKI 303 may transmit a response to the AP 302 including the first digital signature SALTED_PUB_AP_SIGN. If the PKI 303 is not able to find the AP public key PUB_AP, the message may indicate that the PKI 303 is unable to identify or validate the AP 302.

As further shown in FIG. 3, at operation S316, based on receiving the first digital signature SALTED_PUB_AP_SIGN from the PKI 303, the AP 302 may transmit a response message to the client device 301 including the information requested in the validation request message of operation S313. In some embodiments, the AP 302 may provide the initial icon again (e.g. the same favicon passed in the beacon frame), or indicate in the response message that it has no icon (e.g., the icon data ICON_DATA may be zero-length), and the client device 301 may validate the icon or lack thereof. In some embodiments, the response message may be sent using an unprotected Public Action frame (e.g. ANQP/GAS Initial Response frame). If the AP 302 did not receive the first digital signature SALTED_PUB_AP_SIGN, the response message may indicate that the AP 302 is unable to provide requested information. In some embodiments, the response message may distinguish between a situation in which for example, the AP 302 does not have a relationship with any of the PKIs included in the list of infrastructure identifiers INFRA_IDs provided by the client device 301, a second situation in which of the PKIs included in the list had the AP public key PUB_AP, a third situation in which the PKI 303 and/or the AP 302 has received too many requests, etc.

As further shown in operation S317, the client device 301 may validate the network and/or the icon based on the response message of operation S316. For example, based on a check of the first digital signature SALTED_PUB_AP_SIGN using the PKI public key PUB_INFRA[INFRA_ID] passing successfully, the client device 301 may learn that the AP public key PUB_AP may be trusted, because an attacker would not have access to the PKI private key PRIV_INFRA[INFRA_ID] to forge the first digital signature SALTED_PUB_AP_SIGN, and may not be able to simply replay a previous digital signature because of the salt value SALT. In addition, based on a check of the second digital signature SALTED_ICON_DATA_SIGN using the validated AP public key PUB_AP passing successfully, the client device 301 may learn that the icon data ICON_DATA may be trusted, because an attacker would not have access to the AP private key PRIV_AP to forge the second digital signature SALTED_ICON_DATA_SIGN, and may not be able to simply replay a previous digital signature because of the salt value SALT. Therefore, based on both of these checks passing successfully, the client device 301 may display the validated icon to the user, and may associate with the network through the AP 302. In embodiments, based on either of these checks failing, the client device 301 may not validate the network corresponding to the AP 302, and may therefore not associate with the network and/or reject the icon.

In some embodiments, the client device 301 may identify itself to the PKI 303, and the PKI 303 may encrypt the first digital signature SALTED_PUB_AP_SIGN with a client public key or otherwise validate the client, so that the PKI 303 may restrict the clients to which it provides the service. In some embodiments, the AP 302 may further provide public keys for other APs, and/or the client device 301 may make requests to multiple APs in parallel, in order to speed up the process.

In some embodiments, if the icon was not received by the client device in the response message of operation S316, the icon may be obtained at another time, for example using ANQP/GAS, or otherwise.

In some embodiments, the client device 301 may provide a DH public key, and the AP 302 may return the icon data ICON_DATA encrypted using a shared secret derived from the AP private key PRIV_AP and the DH public key. In some embodiments, the shared secret can be derived as described in Internet Engineering Task Force (IETF) Request for Comments (RFC) 8110, the contents of which are incorporated by reference herein in their entirety, but embodiments are not limited thereto.

Some embodiments may guard against connecting to an impostor network, which may refer to an attacker AP in range of the client device 301 that has the same SSID and BSSID as the AP 302. For example, if the AP 302 uses Opportunistic Wireless Encryption (OWE), then in addition to the DH element exchange in the association request/response, the shared secret may be encrypted by the AP using the AP private key PRIV_AP and returned to the client device 301, a digital signature of the shared secret generated using the AP private key PRIV_AP may be returned to the client device 301, or a Hash-based Message Authentication Code (HMAC) corresponding to the shared secret may be returned to the client device 301. If the AP uses Wi-Fi Protected Access 2 (WPA2) or Wi-Fi Protected Access 3 (WPA3), then a DH exchange may be performed in the association request/response and the shared secret (or signature or HMAC) may be encrypted and sent to the client device 301 in the third message of the four-way (or 4-way) handshake. According to embodiments, if the locally computed shared secret and the decrypted/signed/HMACed shared secret do not match at the client device 301, the client device 301 may abort the connection, because man-in-the-middle (MitM) would not have both the shared secret and the AP private key PRIV_AP. If the AP 302 uses open security (e.g., no security) then no MitM protection may be available, though the icon security remains.

Although an example is provided above in which the AP public key PUB_AP is provided to the client device 301 by the AP 302, embodiments are not limited thereto. For example, in some embodiments the AP public key PUB_AP may be obtained by the client device directly from the PKI 303.

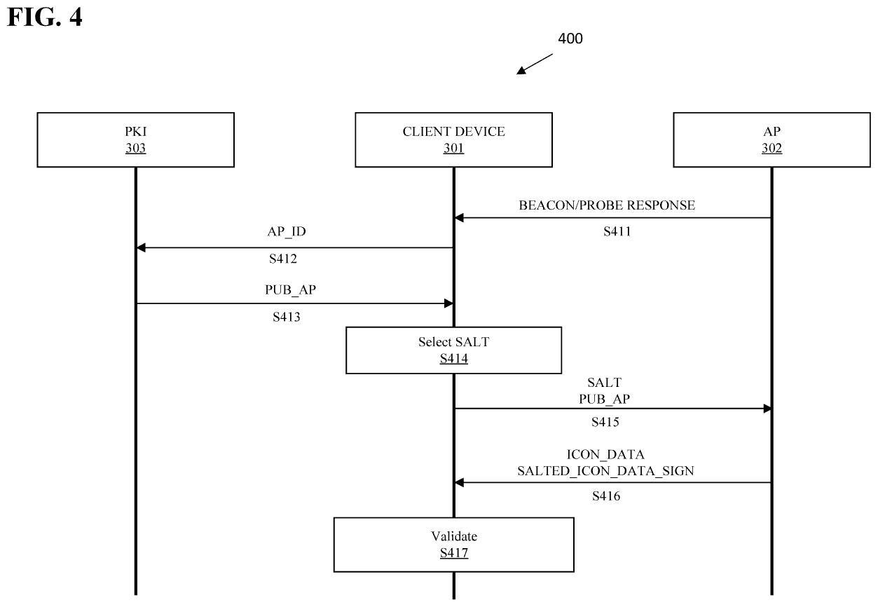

FIG. 4 is a diagram showing an example of a process 400 for validating at least one of an AP and an icon corresponding to the AP, according to embodiments.

As shown in FIG. 4, at operation S411, the AP 302 may transmit an initial message to the client device 301. In some embodiments, operation S411 may correspond to operation S311 discussed above.

As further shown in FIG. 4, at operation S412, the client device 301 may transmit a message to the PKI 303 including the AP identifier AP_ID corresponding to the AP 302, and requesting that the PKI 303 provide the AP public key PUB_AP. In embodiments, this message may be transmitted over a secured channel

As further shown in FIG. 4, at operation S413, the PKI 303 may provide the AP public key PUB_AP. In some embodiments, if the PKI 303 is unable to provide the AP public key PUB_AP, the client device 301 may not validate the network corresponding to the AP 302, and may therefore not associate with the network and/or reject the icon.

As further shown in FIG. 4, at operation S414, the client device 301 may select the salt value SALT. In some embodiments, as discussed above, instead of the salt value SALT, the client device 301 may select a DH public key to be sent to the AP 302.

As further shown in FIG. 4, at operation S415, the client device may transmit a validation request message to the AP 302. In some embodiments, the validation request message may be sent using unicast unencrypted Public Action frames (e.g. an ANQP/GAS Initial Request frame), but embodiments are not limited thereto. The validation request message may include the salt value SALT and the AP public key PUB_AP known to the client device 301, and may request the AP 302 to provide the icon data ICON_DATA and the second digital signature SALTED_ICON_DATA_SIGN. In embodiments, the validation request message may include the AP public key PUB_AP in case the AP 302 has multiple public keys (e.g. supports multiple PKIs). In some embodiments, the validation request message may request that the AP 302 provide the icon data ICON_DATA encrypted using a shared secret derived from the AP private key PRIV_AP and the DH public key of the client device 301.

As further shown in FIG. 4, at operation S416, the AP 302 may transmit a response message including the icon data ICON_DATA and the second digital signature SALTED_ICON_DATA_SIGN. In some embodiments, the AP 302 may provide the initial icon again (e.g. the same favicon passed in the beacon frame), or indicate in the response message that it has no icon (e.g., the icon data ICON_DATA may be zero-length), and the client device 301 may validate the icon or lack thereof. In some embodiments, the icon data ICON_DATA may be encrypted, to stop third-party devices from seeing the icon data ICON_DATA. In some embodiments, the response message may be sent using unicast unencrypted Public Action frames (e.g. an ANQP/GAS Initial Request frame), but embodiments are not limited thereto.

As further shown in FIG. 4, at operation S417, the client device 301 may validate the network and/or the icon based on the response message of operation S316. For example, based on a check of the second digital signature SALTED_ICON_DATA_SIGN using the validated AP public key PUB_AP passing successfully, the client device 301 may learn that the icon data ICON_DATA may be trusted, because an attacker would not have access to the AP private key PRIV_AP to forge the second digital signature SALTED_ICON_DATA_SIGN, and may not be able to simply replay a previous digital signature because of the salt value SALT. Therefore, based on this check passing successfully, the client device 301 may display the validated icon to the user, and may associate with the network through the AP 302. In embodiments, based on this check failing, the client device 301 may not validate the network corresponding to the AP 302, and may therefore not associate with the network and/or reject the icon.

Although FIGS. 3-4 relate to examples in which an icon associated with the AP 302 is validated, embodiments are not limited thereto. For example, in some embodiments, any other information associated with the AP 302, which may be referred to for example as AP information, may be validated. For example, the AP information may include any other type of information or file for identifying the AP 302 (e.g., a sound file indicating the AP 302). As another example, the AP information may include any other media (e.g., a video or moving image), or other information related to or associated with the AP 302 or the PKI 303.

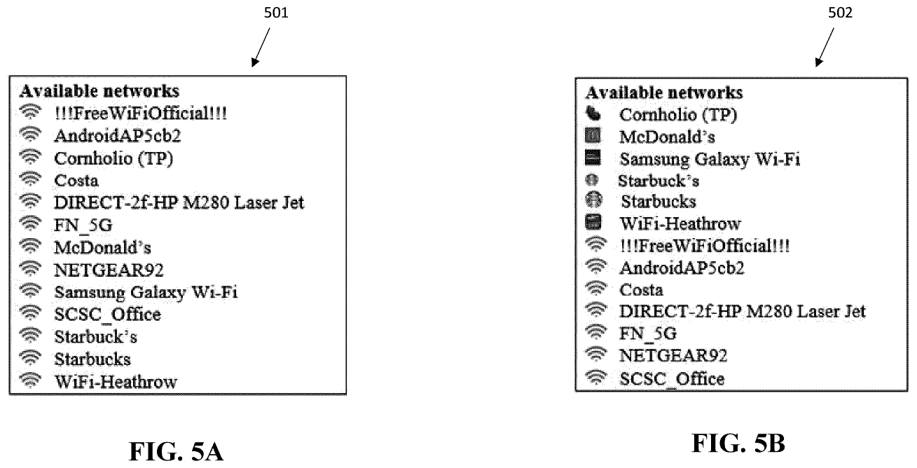

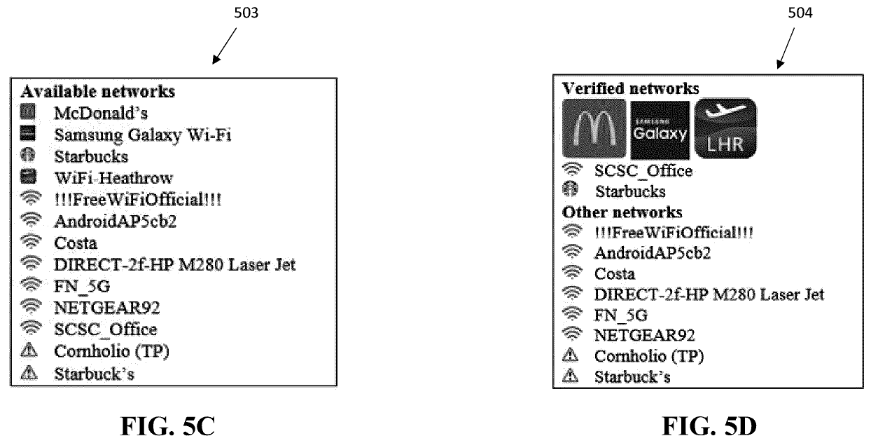

FIGS. 5A-5D show examples of a network picker user interface (UI) which may be displayed by the client device 301, according to embodiments. For example, FIG. 5A shows an example UI 501, which does not include icons. As shown in FIG. 5, it can be difficult to distinguish one network from another.

FIG. 5B shows a UI 502 in which some of the networks are associated with icons. In embodiments, the networks associated with icons may be preferentially shown, for example at a top of the list, and displayed along with the corresponding validated icons. In embodiments, one or more of the icons (e.g., icons that are being fetched or authenticated) may be blurred or hidden, but embodiments are not limited thereto.

FIG. 5C shows a UI 503 in which some of the icons have been validated. As shown in FIG. 5C, two of the networks may be identified as suspect, for example because they are associated with unvalidated icons such as icons which did not validate properly (for example because the networks are impostor networks). In the UI 503, these two networks may be identified or indicated as unvalidated networks, for example by being placed at the bottom of the list and identified with a warning icon, but embodiments are not limited thereto. For example, in some embodiments the UI 503 may provide a warning message if the suspect networks are selected by a user.

FIG. 5D shows a UI 504 in which some of the networks are associated with icons of different sizes and/or resolutions. As shown in FIG. 4, validated or verified networks may be displayed preferentially, for example by being placed at the top of the list, and displayed along with the corresponding validated icons (e.g., larger or higher-resolution icons) where available, or favicons where available otherwise.

In some embodiments, one of the network picker UIs (e.g., the UI 504) may display an alternate SSID, for example an SSID in which the icon is directly incorporated into the text, although this may rely on a particular UI rendering. In some embodiments, the icon may indicate that the network provided by the AP 302 is protected. If so, the AP 302 may notify the client device 301, so that the client device 301 may not additionally provide an icon such as a padlock icon showing the protected status. In some embodiments, the AP 302 may provide multiple icons corresponding to multiple different personas (e.g., personas corresponding to different network providers corresponding to the AP 302, or different levels or tiers of service provided by the AP 302), and the client device 301 may display the appropriate icon.

In some embodiments, the client device 301 may allow a user to report objectionable validated icons to at least one of the network provider and the PKI 303, for example reporting information such as the specific icon that was displayed, and the nature of the objection. In embodiments, this may include connection or performance problems, or a suspicion the AP 302 has been compromised. General issues with the AP public key PUB_AP or icon signing failures may also be reported, for purposes such as diagnostic purposes, or wireless intrusion detection purposes. In embodiments, these reports may not be reported over the AP 302, and may instead be reported using a different AP or a different network or communication technology.

In some embodiments, the PKI 313 may return a priority indication that indicates where the icon should be displayed where among other icons. For example, a network operator may pay extra to try to outbid other network providers, and may therefore be displayed at a top of the list in the network picker UI. Similarly, a network operator might be willing to pay extra to be able to return multiple icons. To support this the infrastructure, would return additional constraint data may be transmitted to the client device 301. In some embodiments, this extra constraint data may be signed by the PKI 303 using the PKI public key PUB_INFRA, so that others (e.g., the AP 302) may not tamper with it. In embodiments, this extra data may include, for example, tag-length-value (TLV) triplets, which may allow extensibility.

In some embodiments, to reduce icon validation latency and airtime cost, the client device 301 may cache icons and AP public keys. Accordingly, the client device 301 may only pass the salt value SALT and the infrastructure identifier INFRA_ID, and request the second digital signature SALTED_ICON_DATA_SIGN and the infrastructure identifier INFRA_ID in the validation request message. The AP 302 may signal, in the initial message, the last time that the icons and AP public keys changed, so that the client device 301 may flush the cache of stale data. In embodiments, the client device 301 may also flush the cache based on the occurrence of a validation failure).

In some embodiments, the client device 301 may specify the maximum physical layer (PHY) rate at which it is able to receive the icon data ICON_DATA.

In some embodiments, the client device 301 may defer validating an icon until a particular network is selected by the user. However, this may open up the risk that malicious icons may be display.

Although examples are provided above in which the AP 302 provides an icon to be validated, embodiments are not limited thereto. For example, in some embodiments the AP 302 may return the initial icon (e.g., the favicon) as the icon, or may return a zero-length icon (e.g., no icon), and may provide a digital signature corresponding to the initial icon or the zero-length icon. In this case, the client device 301 may still validate the network as discussed above. In embodiments, instead of an icon, the AP 302 may return other information corresponding to the AP 302, for example a policy of the AP 302, or any other information, and may provide a digital signature of the information for validation.

In embodiments, the AP 302 may broadcast the icon, for example at a relatively low rate so that distant and/or untrimmed clients may receive it. This may be done to prevent the icon from being restricted to only certain clients.

In some embodiments, instead of validating icons locally using a digital signature, the PKI 303 may store the secure hash of the icon, and the client device 301 may request the secure hash and compare the secure hash with a hash of the icon advertised by the AP 302. This may make it more difficult for the network operator to change the icon, however, as any change would have to be reflected in the PKI 303, and there may be periods of mismatch when the icon is changed. This may mean that any dynamic changes (e.g. day/night or holidays or promotions) may be harder to achieve. This may also hinder the detection of impostor networks by a user.

In some embodiments, the icon itself may be returned by the PKI 303. However, this may increase an amount of data to be carried by the AP 302, may potentially expose the PKI 303 to negative consequences for inappropriate icons, and may not permit early display of a blurred icon (unless the AP 302 advertises a favicon and the PKI 303 provides a full icon).

In some embodiments, the AP 302 may be willing to provide Internet access for validation (and optionally delivery) of an icon it is transmitting, so that the client device 301 may validate the icon without other connectivity (or without other free connectivity). In some embodiments, this may be achieved, for example, by the same mechanisms as currently allow messaging services to be used for free on airplanes even though full Internet access is chargeable. In some embodiments, the AP 302 may offer (and advertise) an open network specifically for this purpose, with the main network being protected. The client device 301 and the PKI 303 may layer additional security (e.g. authentication of the PKI 303 at least) on top of this, because the AP 302 doing so may not be validated yet.

Although examples are described above which relate to icons, embodiments are not limited thereto. For example, embodiments may be applied to any type of media, for example to graphics or images other than icons, to video, or to audio or sound (which may be helpful for user with visual impairments), etc. The validation request message sent by the client device 301 to the AP 302 may indicate the desired media type or types. In embodiments, the client device 301 may be able to choose from multiple media items (e.g. multiple graphic sizes or resolutions, or both a graphic and a video).

Although examples are described above which relate to APs, embodiments are not limited thereto. For example, embodiments may be applied to other devices which allow connection or association, for example mobile hotspots or personal hotspots. In some embodiments, if an icon is to be validated, this may involve the mobile hotspot or personal hotspot having a procedure to dynamically and securely update the infrastructure using its SSID and BSSID, and receiving a temporary private key in return. This temporary private key may then be used to sign the icon, as discussed in the examples above, so that the client device 301 may use the corresponding temporary public key to validate the authenticity of the icon. However, embodiments are not limited thereto, and in some embodiments, an icon may be validated without updating the infrastructure of the mobile hotspot or personal hotspot. In addition, embodiments may be applied to other networks, for example a Wi-Fi Direct network and a Neighborhood Area Network (NAN).

Although examples are described above which relate to validating an icon, embodiments are not limited thereto. For example, embodiments may be applied to any other part output of the AP 302, or may be used to secure any other input or output of the client device 301, based on having the AP public key PUB_AP.

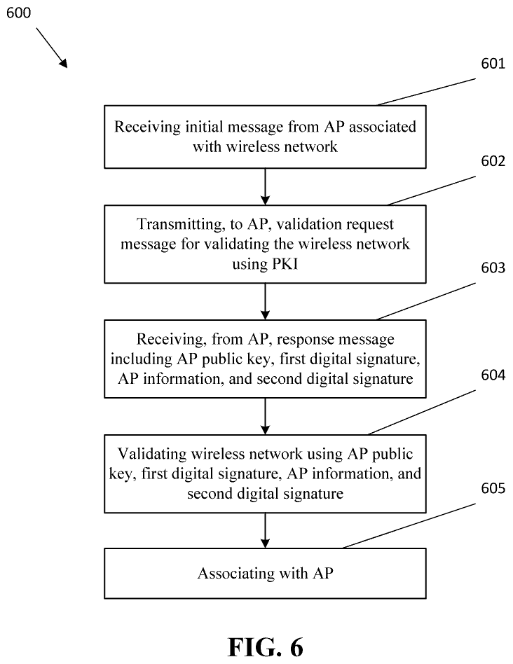

FIG. 6 is a flow chart of process 600 for validating a wireless network. In some implementations, one or more process blocks of FIG. 6 may be performed by one or more of the elements discussed above, for example one or more of the STA 201, the AP 202, the client device 301, the AP 302, the PKI 303, and the elements included therein.

As shown in FIG. 6, at operation S601 the process 600 may further include receiving, by a client device, an initial message from an AP associated with the wireless network. In embodiments, the client device may correspond to the client device 301, and the AP may correspond to the AP 302 discussed above.

As further shown in FIG. 6, at operation S602 the process 600 may further include transmitting, to the AP, a validation request message for validating the wireless network using a PKI, wherein the PKI is associated with a PKI public key and a PKI private key. In embodiments, the PKI may correspond to the PKI 303 discussed above, and the validation request message may correspond to the validation request message discussed above with reference to operation S313 of FIG. 3.

As further shown in FIG. 6, at operation S603 the process 600 may further include receiving, from the AP, a response message including an AP public key associated with the AP, a first digital signature that is generated based on the AP public key using the PKI private key, AP information regarding the AP, and a second digital signature that is generated based on the AP information using an AP private key associated with the AP. In embodiments, the response message may correspond to the response message discussed above with reference to operation S316 of FIG. 3. In embodiments, the AP information may correspond to the icon associated with the AP 302 discussed above, or any other information associated with the AP 302.

As further shown in FIG. 6, at operation S604 the process 600 may further include validating the wireless network using the AP public key, the first digital signature, the AP information, and the second digital signature.

As further shown in FIG. 6, at operation S605 the process 600 may further include associating with the AP based on the validation being completed successfully.

In embodiments, the validating the wireless network may include validating the AP public key using the PKI public key and the first digital signature; and validating the AP information using the validated AP public key and the second digital signature.

In embodiments, the process 600 may further include selecting a salt value based on the receiving the initial message, the validation request message may include the salt value, and the first digital signature and the second digital signature may be generated based on the salt value. In embodiments, the salt value may correspond to the salt value SALT discussed above.

In embodiments, the validation request message may include an infrastructure identifier corresponding to the PKI, and the response message may include the infrastructure identifier. In embodiments, the infrastructure identifier may correspond to the infrastructure identifier INFRA_ID discussed above.

In embodiments, the initial message may include an initial icon corresponding to the wireless network, the AP information may include a validated icon corresponding to the wireless network, and the process 600 may further include displaying the initial icon based on receiving the initial message, and displaying the validated icon based on validating the wireless network.

In embodiments, the wireless network may be an IEEE 802.11 WLAN, and the access point may be associated with the WLAN.

In embodiments, the initial message may include one from among a beacon frame and a probe response frame.

In embodiments, the validation request message and the response message may be transmitted using ANQP.

In embodiments, the associating may include receiving, from the AP, a shared secret and a third digital signature that is generated based on the shared secret using the AP private key.

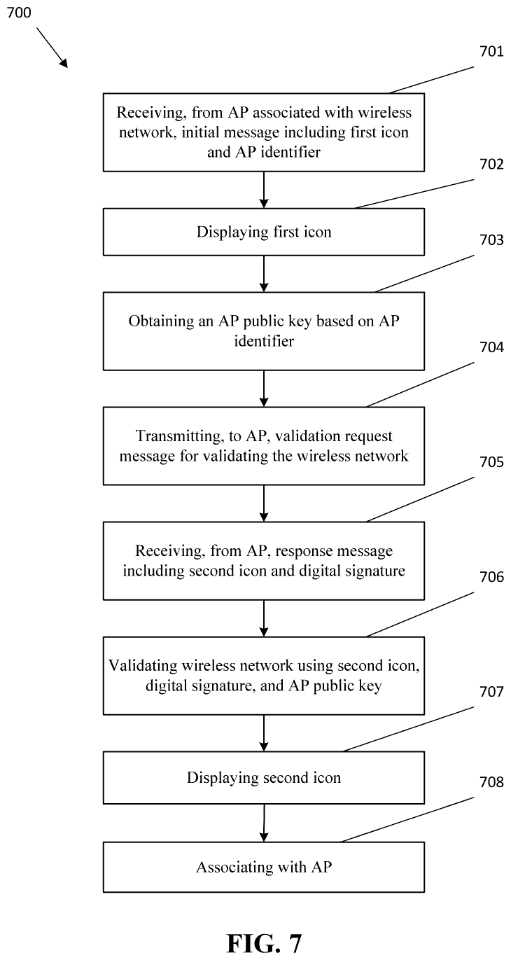

FIG. 7 is a flow chart of process 700 for validating a wireless network. In some implementations, one or more process blocks of FIG. 7 may be performed by one or more of the elements discussed above, for example one or more of the STA 201, the AP 202, the client device 301, the AP 302, the PKI 303, and the elements included therein.

As shown in FIG. 7, at operation S701 the process 700 may include receiving, by a client device, an initial message from an AP associated with the wireless network, wherein the initial message includes a first icon corresponding to the wireless network and an AP identifier corresponding to the AP. In embodiments, the client device may correspond to the client device 301, and the AP may correspond to the AP 302 discussed above.

As further shown in FIG. 7, at operation S702 the process 700 may further include displaying the first icon on a display included in the client device. In embodiments, the first icon may correspond to the initial icon discussed above.

As further shown in FIG. 7, at operation S703 the process 700 may further include based on the AP identifier, obtaining an AP public key associated with the AP. In embodiments, the obtaining of the AP public key may correspond to operations S412 and S413 of FIG. 4.

As further shown in FIG. 7, at operation S704 the process 700 may further include transmitting, to the AP, a validation request message for validating the wireless network. In embodiments, the validation request message may correspond to the validation request message discussed above with reference to operation S415 of FIG. 4.

As further shown in FIG. 7, at operation S705 the process 700 may further include receiving, from the AP, a response message including a second icon associated with the wireless network and a digital signature that is generated based on the second icon using an AP private key associated with the AP. In embodiments, the response message may correspond to the response message discussed above with reference to operation S416 of FIG. 4.

As further shown in FIG. 7, at operation S706 the process 700 may further include validating the wireless network using the second icon, the digital signature, and the AP public key.

As further shown in FIG. 7, at operation S707 the process 700 may further include displaying the second icon on the display based on the validation being completed successfully. In embodiments, the second icon may correspond to the validated icon discussed above.

As further shown in FIG. 7, at operation S708 the process 700 may further include associating with the AP based on the validation being completed successfully.

In embodiments, the wireless network may be an IEEE 802.11 WLAN, and the access point may be associated with the WLAN.

In embodiments, the initial message may include one from among a beacon frame and a probe response frame.

In embodiments, the validation request message and the response message may be transmitted using ANQP.

In embodiments, the associating may include receiving, from the AP, a shared secret and a third digital signature that is generated based on the shared secret using the AP private key.

Although FIGS. 3, 4, 6, and 7 show example blocks of processes 300, 400, 600, and 700, in some implementations, processes 300, 400, 600, and 700 may include additional blocks, fewer blocks, different blocks, or differently arranged blocks than those depicted in FIGS. 3, 4, 6, and 7. Additionally, or alternatively, two or more of the blocks of processes 300, 400, 600, and 700 may be performed in parallel, or may be combined in any order.

The disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. A singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “1st” and “2nd”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., via wires), wirelessly, or via a third element.

As used in connection with the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (ASIC).

One or more embodiments as set forth herein may be implemented as software including one or more instructions that are stored in a storage medium that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to one or more embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one or more embodiments, each component (e.g., a module or a program) of the above-described components may include a single entity or multiple entities. According to one or more embodiments, one or more of the above-described components may be omitted, or one or more other components may be added. Alternatively or additionally, a plurality of components (e.g., modules or programs) may be integrated into a single component. In such a case, according to one or more embodiments, the integrated component may still perform one or more functions of each of the plurality of components in the same or similar manner as they are performed by a corresponding one of the plurality of components before the integration. According to one or more embodiments, operations performed by the module, the program, or another component may be carried out sequentially, in parallel, repeatedly, or heuristically, or one or more of the operations may be executed in a different order or omitted, or one or more other operations may be added.

According to one or more embodiments, in a non-volatile storage medium storing instructions, the instructions may be configured to, when executed by at least one processor, cause the at least one processor to perform at least one operation. The at least one operation may include displaying an application screen of a running application on a display, identifying a data input field included in the application screen, identifying a data type corresponding to the data input field, displaying at least one external electronic device, around the electronic device, capable of providing data corresponding to the identified data type, receiving data corresponding to the identified data type from an external electronic device selected from among the at least one external electronic device through a communication module, and entering the received data into the data input field.

The embodiments of the disclosure described in the present specification and the drawings are only presented as specific examples to easily explain the technical content according to the embodiments of the disclosure and help understanding of the embodiments of the disclosure, not intended to limit the scope of the embodiments of the disclosure. Therefore, the scope of one or more embodiments of the disclosure should be construed as encompassing all changes or modifications derived from the technical spirit of one or more embodiments of the disclosure in addition to the embodiments disclosed herein.

1. A client device comprising:
a transceiver;
at least one processor; and
a memory configured to store instructions which, when executed by the at least one processor, cause the client device to:
receive an initial message from an access point (AP) associated with a wireless network,
transmit, to the AP, a validation request message for validating the wireless network using a public key infrastructure (PKI), wherein the PKI is associated with a PKI public key and a PKI private key,
receive, from the AP, a response message comprising an AP public key associated with the AP, a first digital signature that is generated based on the AP public key using the PKI private key, AP information regarding the AP, and a second digital signature that is generated based on the AP information using an AP private key associated with the AP, and
validate the wireless network using the AP public key, the first digital signature, the AP information, and the second digital signature.

2. The client device of claim 1, wherein to validate the wireless network, the instructions further cause the at least one processor to:
validate the AP public key using the PKI public key and the first digital signature, and
validate the AP information using the validated AP public key and the second digital signature.

3. The client device of claim 1, wherein the instructions further cause the at least one processor to select a salt value based on receiving the initial message,
wherein the validation request message comprises the salt value, and
wherein the first digital signature and the second digital signature are generated based on the salt value.

4. The client device of claim 1, wherein the validation request message further comprises an infrastructure identifier corresponding to the PKI, and
wherein the response message further comprises the infrastructure identifier.

5. The client device of claim 1, wherein the AP information comprises a validated icon corresponding to the wireless network, and
wherein the instructions further cause the at least one processor to display the validated icon based on validating the wireless network.

6. The client device of claim 5, wherein the initial message comprises an initial icon corresponding to the wireless network, and
wherein the instructions further cause the at least one processor to display the initial icon based on receiving the initial message,
wherein the initial icon and the validated icon are displayed in a user interface (UI), and
wherein the UI comprises a plurality of unvalidated icons corresponding to unvalidated wireless networks, and a plurality of validate icons corresponding to validated wireless networks.

7. The client device of claim 1, wherein the wireless network is an Institute of Electrical and Electronics Engineers (IEEE) 802.11 wireless local area network (WLAN),
wherein the access point is associated with the WLAN.

8. The client device of claim 7, wherein the initial message comprises one from among a beacon frame and a probe response frame.

9. The client device of claim 7, wherein the validation request message is transmitted using Access Network Query Protocol (ANQP), and
wherein the response message is received using ANQP.

10. The client device of claim 7, wherein the instructions further cause the at least one processor to, after the wireless network is validated, perform an association and four-way handshake process with the AP,
wherein the association and four-way handshake process comprises receiving, from the AP, a shared secret generated based on the AP public key, and a third digital signature generated based on the shared secret using the AP private key.

11. A client device comprising:
a transceiver;
a display;
at least one processor; and
a memory configured to store instructions which, when executed by the at least one processor, cause the client device to:
receive an initial message from an access point (AP) associated with a wireless network, wherein the initial message comprises a first icon corresponding to the wireless network and an AP identifier corresponding to the AP,
display the first icon on the display,
based on the AP identifier, obtain an AP public key associated with the AP,
transmit, to the AP, a validation request message for validating the wireless network,
receive, from the AP, a response message comprising a second icon associated with the wireless network and a digital signature that is generated based on the second icon using an AP private key associated with the AP,
validate the wireless network using the second icon, the digital signature, and the AP public key, and
based on the wireless network being validated, display the second icon on the display.

12. The client device of claim 11, wherein the AP public key is obtained from a public key infrastructure (PKI) through a secure channel shared by the PKI and the client device.

13. The client device of claim 11, wherein the instructions further cause the at least one processor to select a salt value based on receiving the initial message,
wherein the validation request message comprises the salt value and the AP public key, and
wherein the digital signature is generated based on the salt value.

14. The client device of claim 11, wherein the wireless network is an Institute of Electrical and Electronics Engineers (IEEE) 802.11 wireless local area network (WLAN),
wherein the access point is associated with the WLAN.

15. The client device of claim 14, wherein the initial message comprises one from among a beacon frame and a probe response frame.

16. The client device of claim 14, wherein the instructions further cause the at least one processor to, after the wireless network is validated, perform an association and four-way handshake process with the AP,
wherein the association and four-way handshake process comprises receiving, from the AP, a shared secret generated based on the AP public key, and a third digital signature generated based on the shared secret using the AP private key.

17. A method of validating a wireless network performed by at least one processor included in a client device, the method comprising:
receiving an initial message from an access point (AP) associated with the wireless network;
transmitting, to the AP, a validation request message for validating the wireless network using a public key infrastructure (PKI), wherein the PKI is associated with a PKI public key and a PKI private key;
receiving, from the AP, a response message comprising an AP public key associated with the AP, a first digital signature that is generated based on the AP public key using the PKI private key, AP information regarding the AP, and a second digital signature that is generated based on the AP information using an AP private key associated with the AP; and
validating the wireless network using the AP public key, the first digital signature, the AP information, and the second digital signature.

18. The method of claim 17, wherein the validating the wireless network comprises:
validating the AP public key using the PKI public key and the first digital signature; and
validating the AP information using the validated AP public key and the second digital signature.

19. The method of claim 17, further comprising selecting a salt value based on the receiving the initial message,
wherein the validation request message comprises the salt value, and
wherein the first digital signature and the second digital signature are generated based on the salt value.

20. The method of claim 17, wherein the validation request message further comprises an infrastructure identifier corresponding to the PKI, and
wherein the response message further comprises the infrastructure identifier.

21-32. (canceled)
